(19) United States
(12) Patent Application Publication
(10) Pub. No.: US 2004/0208621 A1
(43) Pub. Date: Oct. 21, 2004

(54) Higher-order PMD mitigation based on optical signal filtering

(76) Inventors: Herbert Haunstein, Dormitz (DE); Lothar Moeller, Hazlet, NJ (US); Jeffrey H. Sinsky, Marlboro, NJ (US)

Correspondence Address: MENDELSOHN AND ASSOCIATES PC, 1515 MARKET STREET, SUITE 715, PHILADELPHIA, PA, 19102, US

(21) Appl. No.: 10/157,509

(22) Filed: May 29, 2002

(51) Int. Cl. H04B 10/00; H04B 10/12

(52) U.S. Cl. 398/159

(57) ABSTRACT

A method for reducing deleterious effects of higher-order polarization mode dispersion (PMD) on the quality of data transmission in a long-haul optical communication system. An optical bandpass filter (OBF) designed for spectral bandwidth reduction of a received data-modulated optical signal is placed at the receiver end of the communication system next to a first-order PMD compensator. The OBF may be, e.g., a Mach-Zehnder filter having a bandwidth approximately equal to a modulation frequency of the optical signal. A center frequency of the OBF may be detuned from that of the optical signal. Using the OBF at the receiver may decrease a number of optical bit errors associated with the effects of higher-order PMD.

### BACKGROUND OF THE INVENTION

1. Field of the Invention

The present invention relates to optical communication equipment and, more specifically, to reducing effects of polarization mode dispersion (PMD).

2. Description of the Related Art

Polarization mode dispersion (PMD) occurs in an optical fiber as a result of small birefringence induced by deviations of the fiber's core from a perfectly cylindrical shape, asymmetric stresses or strains, and random external forces acting upon the fiber. PMD is well known to severely impair transmission of optical signals at relatively high bit rates (e.g., 10 Gb/s) over relatively large distances (e.g., 100 km).

One effect of PMD is that different polarization components of an optical signal travel in a fiber at different speeds such that a differential group delay (DGD) is introduced between those components. This effect is generally referred to as first-order PMD. Another effect of PMD is that the shapes of the optical pulses corresponding to different polarization components are distorted differently in the fiber. For example, an optical pulse corresponding to a first principal state of polarization (PSP) may be broadened whereas an optical pulse corresponding to a second PSP may be narrowed. This effect is generally referred to as higher-order PMD. Within higher-order PMD, specific pulse shape distortions corresponding to the second-, third-, etc., orders of PMD may be discriminated. Both first-order PMD and higher-order PMD may significantly distort optical pulses corresponding to optical bits and consequently cause errors at the receiver.

Several techniques have been proposed to date to mitigate the effects of PMD in optical communication systems. Typically, a device known as a PMD compensator is deployed at the receiver end of a fiber link to ensure that the receiver correctly decodes PMD-distorted optical bits.

FIG. 1 shows an exemplary optical communication system 100 having a PMD compensator. System 100 is configured to transmit data-modulated optical signals from one or more transmitters 102 to one or more receivers 114 over a long-haul fiber optic link 106. System 100 may be a wavelength division multiplexing (WDM) system employing a multiplexer 104 and a demultiplexer 110 configured to combine and separate, respectively, optical signals corresponding to different wavelengths or communication channels of system 100. Depending on the length of link 106, one or more optical amplifiers 108 may be included in the link to compensate for the attenuation of optical signals in the fiber. A PMD compensator 112 is deployed for each channel at the corresponding receiver 114 to reduce PMD distortions accrued in link 106.

FIG. 2 shows an exemplary prior art implementation of PMD compensator 112. Compensator 112 comprises a polarization controller (PC) 202, a variable DGD element 204, a state of polarization (SOP) monitor 206, and control electronics 208. PC 202 receives a PMD-distorted optical signal and separates it into two PSP components. DGD element 204 subjects a faster PSP component to a compensating delay to realign it with a slower PSP component. The two PSP components are then recombined and directed to a receiver (e.g., receiver 114 of FIG. 1) for decoding. The output of DGD element 204 is tapped and analyzed by SOP monitor 206, which is configured to provide feedback to PC 202 and DGD element 204 via control electronics 208. Using the feedback, the settings of PC 202 and DGD element 204 are adaptively changed to correspond to the dynamically varying amount of PMD in the fiber (e.g., link 106).

Certain implementations of PMD compensator 112 illustrated in FIG. 2 are described in commonly owned U.S. Pat. No. 5,930,414 by Fishman, et al., the teachings of which are incorporated herein by reference. However, one problem with a PMD compensator, such as that of FIG. 2, is that it may compensate well for the effects of first-order PMD while leaving signal distortions associated with higher-order PMD substantially untreated.

### SUMMARY OF THE INVENTION

Embodiments of the present invention may reduce deleterious effects of higher-order polarization mode dispersion (PMD) on the quality of data transmission in a long-haul optical communication system. An optical bandpass filter (OBF) designed for spectral bandwidth reduction of a received data-modulated optical signal is placed at the receiver end of the communication system next to a first-order PMD compensator. The OBF may be, e.g., a Mach-Zehnder filter having a bandwidth approximately equal to a modulation frequency of the optical signal. A center frequency of the OBF may be detuned from that of the optical signal. Using the OBF at the receiver may decrease the outage probability of the system associated with the effects of higher-order PMD.

According to one embodiment, the present invention is a method for reducing distortions due to PMD in an optical signal transmitted via an optical link in an optical communication system, the method comprising the steps of: (A) reducing signal distortions corresponding to first-order PMD; and (B) filtering the optical signal using an OBF to reduce a spectral bandwidth corresponding to the optical signal, wherein signal distortions corresponding to higher-order PMD are reduced.

According to another embodiment, the present invention is an apparatus for reducing distortions due to PMD in an optical signal transmitted via an optical link in an optical communication system, the apparatus comprising: (A) a PMD compensator configured to reduce signal distortions corresponding to first-order PMD; and (B) an OBF connected to the PMD compensator and configured to reduce signal distortions corresponding to higher-order PMD.

According to yet another embodiment, the present invention is an optical communication system, comprising: (i) a transmitter and a receiver communicating via an optical link; and (ii) an apparatus for reducing distortions due to PMD in an optical signal transmitted via the optical link, the apparatus comprising: (A) a PMD compensator configured to reduce signal distortions corresponding to first-order PMD; and (B) an OBF connected to the PMD compensator and configured to reduce signal distortions corresponding to higher-order PMD, wherein the apparatus is coupled between the optical link and the receiver.

### BRIEF DESCRIPTION OF THE DRAWINGS

Other aspects, features, and advantages of the present invention will become more fully apparent from the following detailed description, the appended claims, and the accompanying drawings in which:

FIG. 1 shows an exemplary prior art optical communication system configured with PMD compensators;

FIG. 2 shows an exemplary prior art implementation of a PMD compensator that may be used in the system of FIG. 1;

FIG. 3 illustrates the principle of first-order PMD compensation using the PMD compensator of FIG. 2;

FIG. 4 shows an optical communication system configured with an optical bandpass filter according to one embodiment of the present invention;

FIG. 5 illustrates spectra corresponding to optical signals that may be transmitted in the system of FIG. 4 according to one implementation of the present invention;

FIGS. 6A-D show representative eye diagrams corresponding to the optical signals illustrated in FIG. 5;

FIG. 7 illustrates spectra corresponding to optical signals that may be transmitted in the system of FIG. 4 according to two additional implementations of the present invention; and

FIGS. 8A-D show representative eye diagrams corresponding to the optical signals illustrated in FIG. 7.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

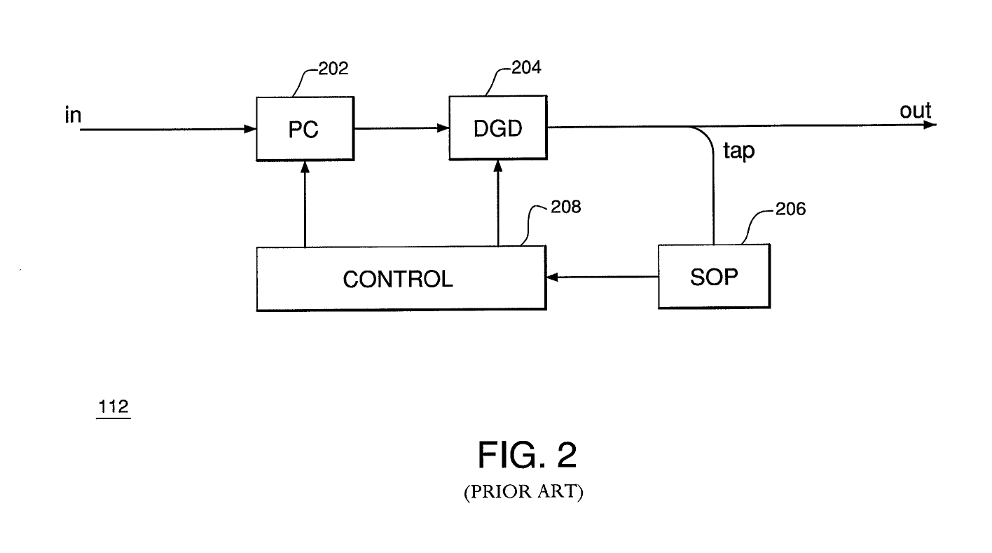

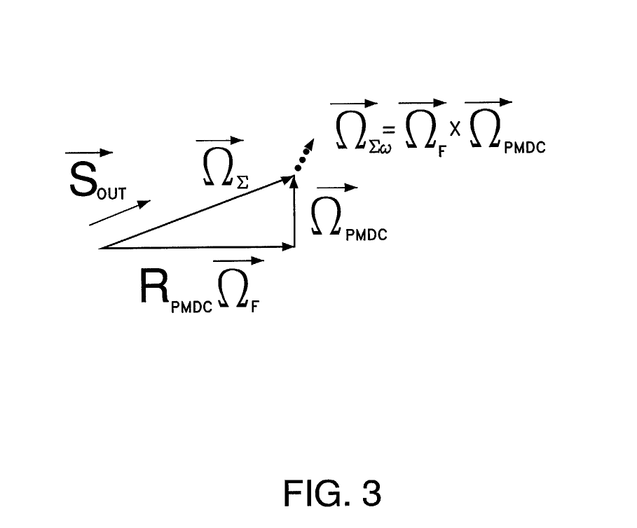

FIG. 3 illustrates the principle of first-order PMD compensation, e.g., in system 100 using PMD compensator 112 shown in FIG. 2. Vectors designated as Ω_{F} and Ω_{PMDC} represent in Stokes space the first-order PMD vectors corresponding to link 106 and PMD compensator 112, respectively. As known in the art, a composite PMD vector (designated as Ω_{Σ} in FIG. 3) representing a cumulative effect of link 106 and PMD compensator 112 can be obtained by (i) applying a corresponding Muller matrix, R_{PMDC}, to vector Ω_{F} and (ii) performing a vector addition operation between the resulting vector and vector Ω_{PMDC}.

Frequency dependence of a vector corresponding to the SOP of the output optical signal (designated as Sₒᵤₜ in FIG. 3) of PMD compensator 112 may be obtained from a cross vector product of vectors Ω_{Σ} and Sₒᵤₜ as given by Equation (1):

$$\frac{\partial {{S}^{->}}_{out}}{\partial ω} = {{Ω}^{->}}_{\sum } \times {{S}^{->}}_{out} = \{ {{Ω}^{->}}_{\sum } ( {ω}_{0} ) + {{Ω}^{->}}_{\sum ω} ( {ω}_{0} ) δω + \frac{1}{2} {{Ω}^{->}}_{\sum ωω} ( {ω}_{0} ) {δω}^{2} + … \} \times {{S}^{->}}_{out} \qquad ( 1 )$$

where vector Ω_{Σ} is expanded into a Taylor series about the center frequency ω₀ and δω is a deviation from the center frequency. The coefficients of the series, i.e., Ω_{Σ}(ω₀), Ω_{Σω}(ω₀), and Ω_{Σωω}(ω₀), correspond to the first-, second-, and third-order PMD, respectively. The effect of PMD compensator 112 is such that vector Sₒᵤₜ is collinear (i.e., parallel or anti-parallel) with vector Ω_{Σ}(ω₀) thus zeroing the corresponding cross vector product and reflecting the fact that the first-order PMD is compensated. Consequently, further PMD compensation is related to the higher-order PMD, e.g., as represented in Equation (1) by vectors Ω_{Σω}(ω₀) and Ω_{Σωω}(ω₀). Since the terms in Equation (1) corresponding to the higher-order PMD include various powers of δω, a bandwidth limitation on the signal may decrease those terms and therefore reduce the contribution of higher-order PMD into signal distortion. In some instances, vectors Sₒᵤₜ and Ω_{Σ}(ω₀) may deviate from collinearity (e.g., in a case of incomplete first-order PMD compensation). However, a similar bandwidth limitation on the signal may still be applied in those instances to reduce the contribution of higher-order PMD into signal distortion.

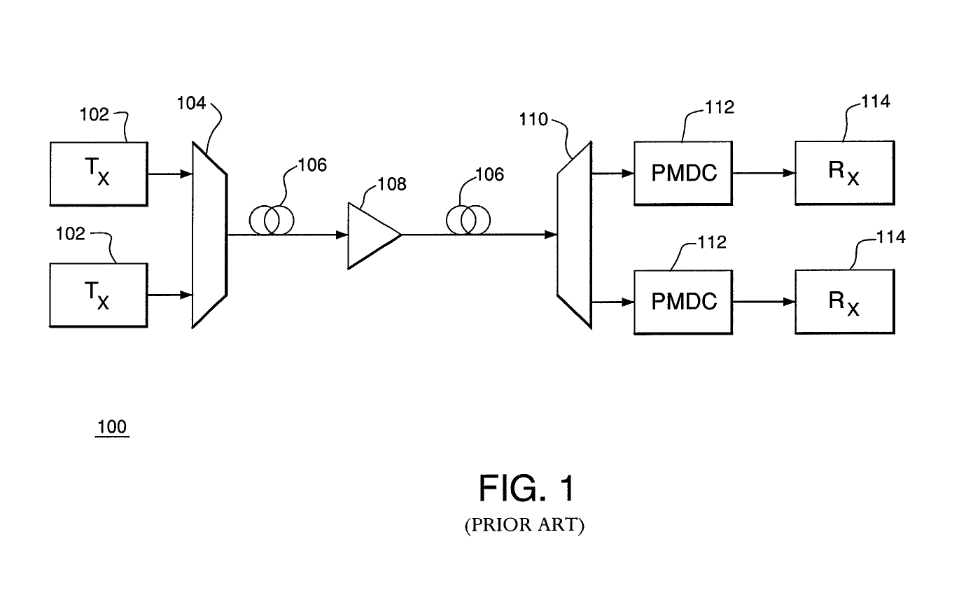

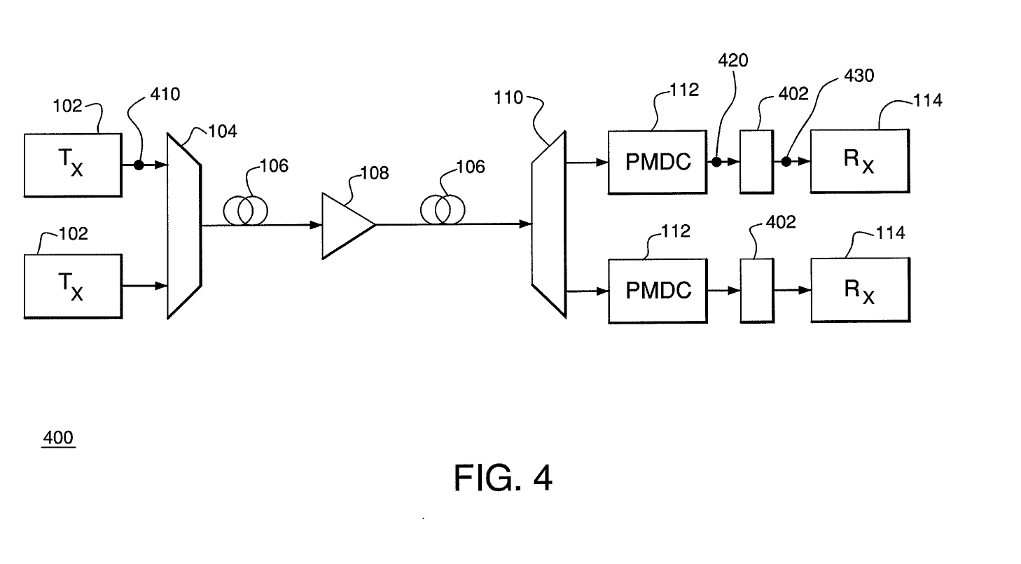

FIG. 4 shows an optical communication system 400 according to one embodiment of the present invention. System 400 is similar to system 100 of FIG. 1 except that an optical bandpass filter (OBF) 402 is inserted between each PMD compensator 112 and the corresponding receiver 114 for spectral bandwidth reduction. In an alternative embodiment, an OBF 402 may be placed in front of each PMD compensator 112 (i.e., between demultiplexer 110 and each PMD compensator 112). As the following description will indicate, OBF 402 may be designed such that optical pulse distortions due to higher-order PMD are significantly reduced, thus decreasing a number of optical bit errors at receiver 114.

In one implementation, OBF 402 may be a Mach-Zehnder filter having a 3-dB bandwidth (defined as a spectral separation between two 3-dB attenuation points on the OBF transmission curve) approximately equal to the modulation frequency of the optical signal (i.e., 10 GHz for a 10 Gb/s signal) transmitted in system 400. A center frequency of OBF 402 may coincide with the center frequency of the optical signal or be offset from that frequency. In other implementations, different OBF types (e.g., Fabri-Perot, Gaussian, etc.) and/or different bandwidths may be used without departing from the principles and scope of the present invention. The following description illustrates representative results and advantages of using different exemplary OBFs for higher-order PMD mitigation in system 400.

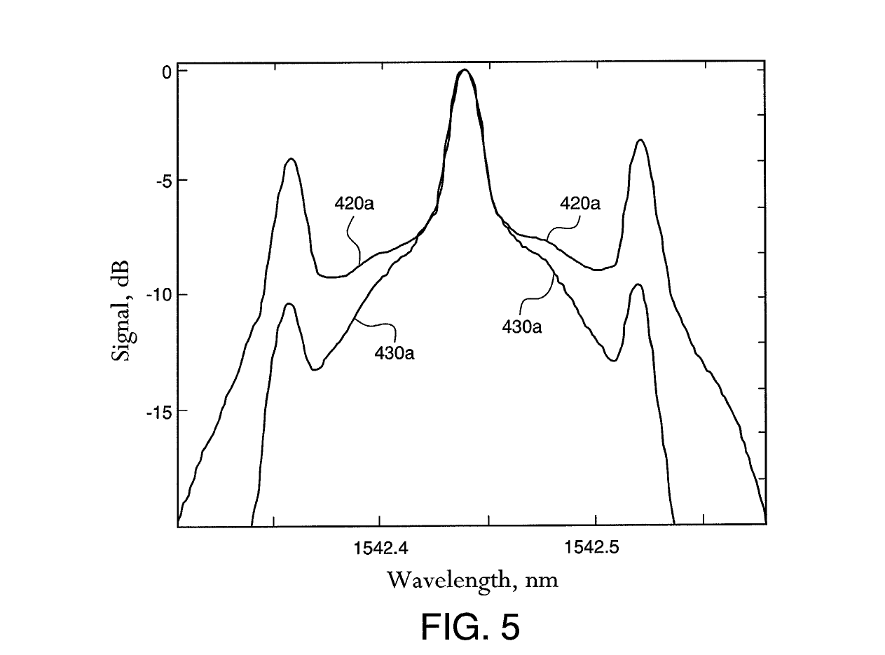

FIG. 5 shows spectra of optical signals corresponding to a 10-Gb/s, 33% duty cycle, pseudo-random RZ optical data signal having a center frequency corresponding to 1542.438 nm (e.g., signal 410 in FIG. 4). In a first implementation, OBF 402 in system 400 is a Mach-Zehnder filter having the same center frequency as signal 410 and a 3-dB bandwidth of 15 GHz. Signal 420a is generated after 10 Gb/s signal 410 is (i) transmitted through link 106 thus undergoing a relatively high amount of PMD distortion in that link and (ii) first-order PMD compensated by the corresponding PMD compensator 112. OBF 402 generates signal 430a from signal 420a. As indicated by FIG. 5, the modulation side bands are symmetrically attenuated by the OBF.

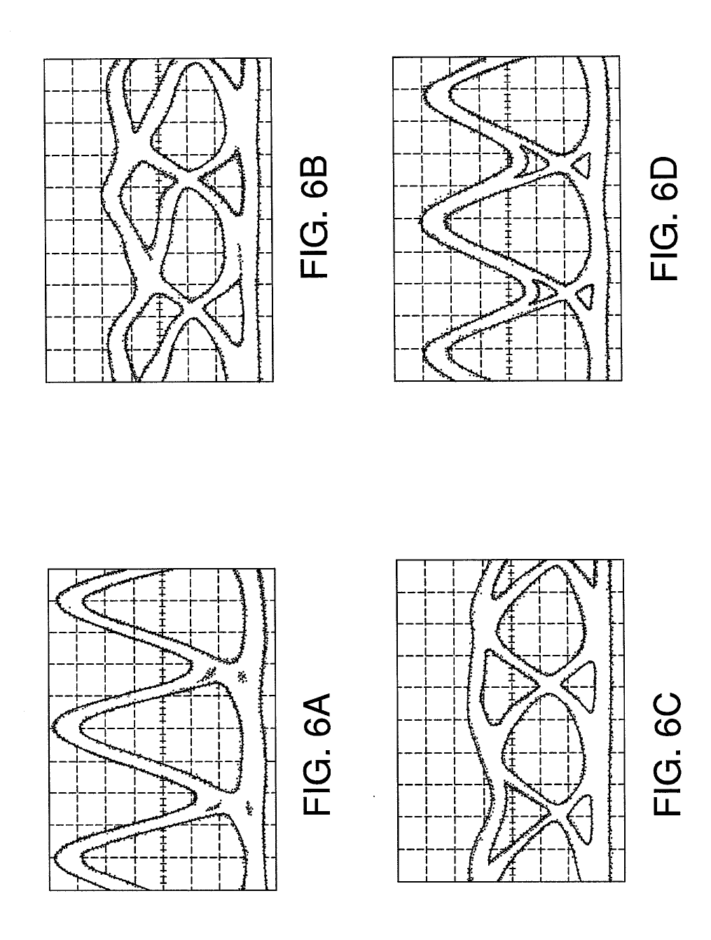

FIGS. 6A-D show representative eye diagrams corresponding to the optical signals illustrated by FIG. 5. FIGS. 6A-C show eye diagrams corresponding to signals 410, 420a, and 430a, respectively. Comparing FIGS. 6B and 6C, one finds that, when a level of PMD is relatively high, the quality of data transmission is improved using the first OBF as indicated by a wider “eye” corresponding to signal 430a compared to that for signal 420a.

Since the amount of PMD may vary dynamically over time, it is desirable to have OBF 402 designed to perform well at different PMD levels. FIG. 6D illustrates the effect of applying OBF 402 to an undistorted signal (e.g., signal 410), thus modeling a possible situation of relatively low PMD. The results of FIGS. 6C-D indicate that OBF 402 performs well when a level of PMD is high or low. More specifically, OBF 402 produces a signal-to-noise ratio (SNR) penalty of only about 0.9 dB for a relatively low amount of PMD (FIG. 6D) and an SNR gain of about 2.4 dB for a relatively high amount of PMD (FIG. 6C). In a preferred embodiment, OBF 402 is designed to reduce an outage probability in system 400 by lowering the effects of relatively high PMD to below a certain threshold. At the same time, OBF 402 is designed not to increase the outage probability in system 400 by imposing a relatively low SNR penalty on the signal when the amount of PMD is relatively low.

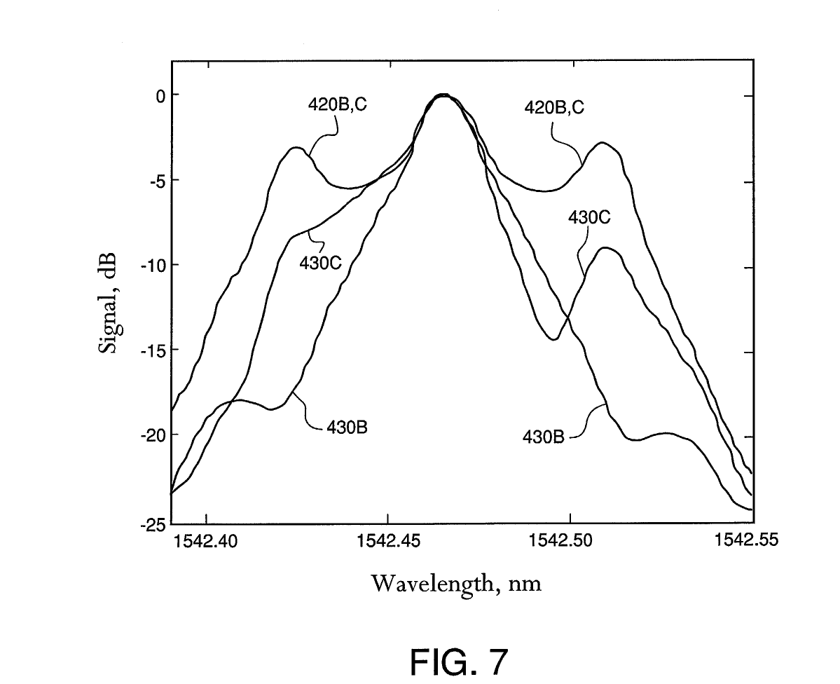

FIG. 7 shows spectra of optical signals in system 400 when signal 410 is a 5-Gb/s, 33% duty cycle, pseudo-random RZ optical data signal having a center frequency corresponding to 1542.462 nm. The effects of two additional implementations of OBF 402 on signal 430 are illustrated in FIG. 7. In a second implementation, OBF 402 is a Mach-Zehnder filter having the same center frequency as the 5-Gb/s optical signal and a 3-dB bandwidth of 5 GHz. In a third implementation, OBF 402 is a Mach-Zehnder filter having a center frequency offset (or detuned) from that of the 5-Gb/s signal by approximately 2 GHz and a 3-dB bandwidth of 5 GHz. Spectra 430b and 430c correspond to signal 430 when the second and third implementation of OBF 402, respectively, is used in system 400. As indicated by FIG. 7, one qualitative difference between the second and third OBF implementations is that the side bands are attenuated either symmetrically or asymmetrically.

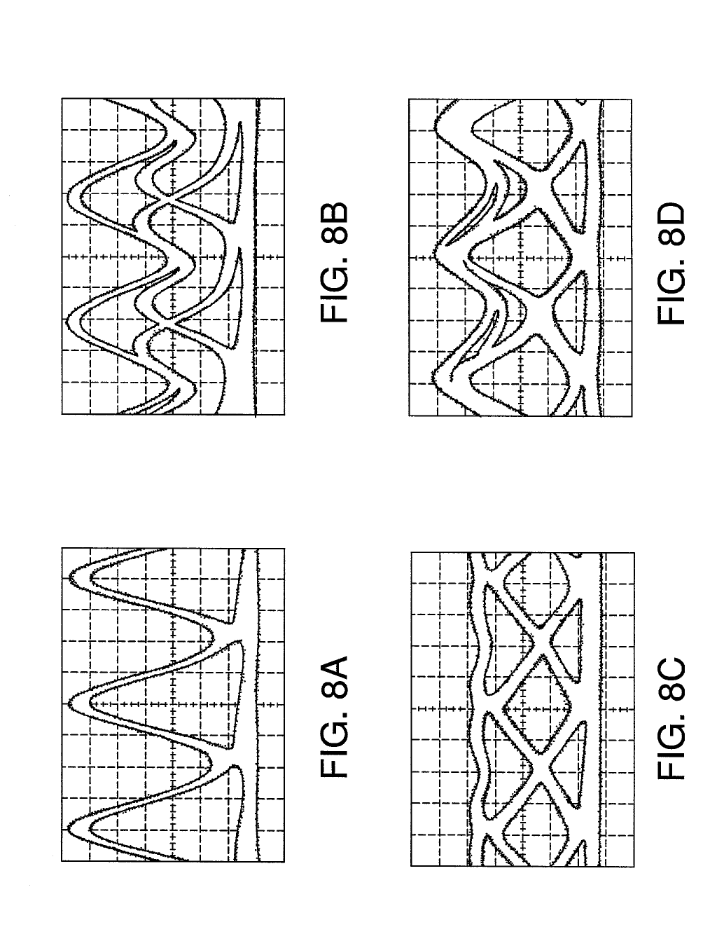

FIGS. 8A-D show representative eye diagrams corresponding to the optical signals illustrated in FIG. 7. More specifically, FIGS. 8A-B show eye diagrams corresponding to signals 410 and 420, respectively. FIGS. 8C and 8D show eye diagrams corresponding to signals 430b and 430c, respectively. Comparing FIGS. 8B-D, one finds that both the second and third OBF implementations improve data transmission. However, in the case illustrated, the third OBF implementation produces a better eye diagram than the second OBF implementation. Thus, the results of FIGS. 8A-D indicate that, in certain situations, the quality of data transmission may be further improved by using an OBF with a center frequency that is offset from that of the optical signal.

While this invention has been described with reference to illustrative embodiments, this description is not intended to be construed in a limiting sense. Various modifications of the described embodiments, as well as other embodiments of the invention, which are apparent to persons skilled in the art to which the invention pertains are deemed to lie within the principle and scope of the invention as expressed in the following claims. For example, the present invention may be practiced in optical communication systems operating at different bit rates and transmitting optical signals using light of different wavelengths. Instead of or in addition to being detuned from the center frequency of an optical signal, an OBF may be designed to have an asymmetrically shaped passband. Also, an OBF may be implemented as part of a demultiplexer (e.g., demultiplexer 112 of system 400).

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A method for reducing distortions due to polarization mode dispersion (PMD) in an optical signal transmitted via an optical link in an optical communication system, the method comprising the steps of:
(A) reducing signal distortions corresponding to first-order PMD; and
(B) filtering the optical signal using an optical bandpass filter (OBF) to reduce a spectral bandwidth corresponding to the optical signal, wherein signal distortions corresponding to higher-order PMD are reduced.

2. The invention of claim 1, wherein a center frequency of the OBF is offset from a center frequency of the optical signal.

3. The invention of claim 1, wherein a bandwidth of the OBF is based on a modulation frequency of the optical signal.

4. The invention of claim 3, wherein the bandwidth of the OBF is approximately equal to the modulation frequency.

5. The invention of claim 1, wherein the OBF is designed to attenuate modulation side bands corresponding to the optical signal.

6. The invention of claim 5, wherein the OBF symmetrically attenuates the modulation side bands.

7. The invention of claim 5, wherein the OBF asymmetrically attenuates the modulation side bands.

8. The invention of claim 1, wherein the spectral passband of the OBF has an asymmetrical shape.

9. The invention of claim 1, wherein the OBF is a Mach-Zehnder filter having:
(i) a 3-dB bandwidth approximately equal to a modulation frequency of the optical signal; and
(ii) a center frequency approximately equal to a center frequency of the optical signal.

10. The invention of claim 1, wherein step (A) is performed before step (B).

11. The invention of claim 1, wherein step (B) is performed before step (A).

12. An apparatus for reducing distortions due to polarization mode dispersion (PMD) in an optical signal transmitted via an optical link in an optical communication system, the apparatus comprising:
(A) a PMD compensator configured to reduce signal distortions corresponding to first-order PMD; and
(B) an optical passband filter (OBF) connected to the PMD compensator and configured to reduce signal distortions corresponding to higher-order PMD.

13. The invention of claim 12, wherein a center frequency of the OBF is offset from a center frequency of the optical signal.

14. The invention of claim 12, wherein a bandwidth of the OBF is based on a modulation frequency of the optical signal.

15. The invention of claim 12, wherein the bandwidth of the OBF is approximately equal to the modulation frequency.

16. The invention of claim 12, wherein the OBF is designed to attenuate modulation side bands corresponding to the optical signal.

17. The invention of claim 16, wherein the OBF symmetrically attenuates the modulation side bands.

18. The invention of claim 17, wherein the OBF asymmetrically attenuates the modulation side bands.

19. The invention of claim 12, wherein the spectral passband of the OBF has an asymmetrical shape.

20. An optical communication system, comprising:
(i) a transmitter and a receiver communicating via an optical link; and
(ii) an apparatus for reducing distortions due to polarization mode dispersion (PMD) in an optical signal transmitted via the optical link, the apparatus comprising:
(A) a PMD compensator configured to reduce signal distortions corresponding to first-order PMD; and
(B) an optical passband filter (OBF) connected to the PMD compensator and configured to reduce signal distortions corresponding to higher-order PMD, wherein the apparatus is coupled between the optical link and the receiver.
